(19) United States
(12) Patent Application Publication
(10) Pub. No.: US 2007/0169199 A1
(43) Pub. Date: Jul. 19, 2007

(54) Web service vulnerability metadata exchange system

(75) Inventors: John Edward Quinnell, Gilroy, CA (US); Mitchel Joneldon Carlsen, Fair Oaks, CA (US); Michael Vernon Ladner, Fair Oaks, CA (US); Jeffrey H. Rudy, San Jose, CA (US); Keith Joseph Smith, Rocklin, CA (US); Arthur Frank Walasek, Folsom, CA (US)

Correspondence Address: KEEVICAN WEISS BAUERLE & HIRSCH LLC;(FORMERLY KNOWN AS DKW LAW GROUP LLC), 11TH FLOOR, FEDERATED INVESTORS TOWER, 1001 LIBERTY AVENUE, PITTSBURGH, PA, 15222, US

(73) Assignee: FORUM SYSTEMS, INC., Sandy, UT (US)

(21) Appl. No.: 11/530,760

(22) Filed: Sep. 11, 2006

Related U.S. Application Data
(60) Provisional application No. 60/715,983, filed on Sep. 9, 2005.

(51) Int. Cl. G06F 11/00

(52) U.S. Cl. 726/25

(57) ABSTRACT

A web service vulnerability metadata exchange system that provides for verification of web services during development by testing for the latest vulnerabilities based on security, policy, and best practice profiles prior to release of the web services, and wherein the web service vulnerability metadata exchange system will automate the surveillance of deployed web services so that new vulnerabilities are profiled and captured for use in verifying new software releases, wherein the system includes a metadata registry coupled to a database including vulnerability metadata, an update manager for updating the database records, and an access manager for authenticating and/or authorizing access to the database records.

### RELATED APPLICATIONS

This application claims the benefit of U.S. Provisional patent application Ser. No. 60/715,983 filed Sep. 9, 2005 entitled “Web Service Vulnerability Metadata Exchange System.”

### BACKGROUND OF THE INVENTION

1. Field of the Invention

The present invention relates to security solutions directed at enterprises developing and deploying web services, more particularly, the present invention relates to security solutions that verify web services during development by testing for the latest vulnerabilities based on security, policy, and best practice profiles prior to release of the web services, and to security solutions that automate the surveillance of deployed web services so that new vulnerabilities are profiled and captured for use in verifying new software releases.

2. Background Information

As noted above the present invention is directed to a security solution for enterprises developing and deploying web services. It has become clear in the past few years that reactive methodologies that treat security vulnerabilities after they have reached production are insufficient even for network and application level vulnerabilities. The additional complexities introduced with web based services will only exacerbate this issue. As noted, the present invention is directed at verifying web services during development by testing for the latest vulnerabilities based on security, policy, and best practice profiles prior to its release, and is directed at automating the surveillance of deployed web services so that new vulnerabilities are profiled and captured for use in web services verifying of new software releases.

The developers of the present invention believe that a large number of publicized exploits are actually application software vulnerabilities that should have been caught prior to release, and that post-deployment network or application vulnerability identification is inefficient and increasingly ineffective. For additional support for these suppositions see academic research publicized by Dr. Barry Boehm at USC. Further the developers of the present system believe that there are distinct enterprise operating differences between Development, Unit Testing, QA and Deployment phases. The developers of the present invention have observed an increasing involvement of application software developers that have variable levels of security expertise and that the ability to incorporate field experience in ongoing software development is now a requirement. The developers of the present invention believe that web services should be developed to be exploit-resistant, but layered approaches to web services lifecycle, including enforcement solutions, are still required for real-time message or attachment inspection. The developers of the present invention have incorporated these observations for forming the unique web service vulnerability metadata exchange system according to the present invention.

Vulnerabilities are generally regarded as any aspect of system or product that allows a breach of security (i.e., a breach of confidentiality, possession, integrity, authenticity, availability, utility or any combination of these principles). However, groups, such as CVE, recognized that “vulnerability” was sometimes used in contradictory ways and so it defined the term “universal vulnerability.” According to CVE, “a universal vulnerability is one that is considered a vulnerability under any commonly used security policy which includes at least some requirements for minimizing the threat from an attacker. A universal vulnerability allows an attacker to: Execute commands as another user; or Access data that is contrary to the specified access restrictions for that data; or Pose as another entity; or Conduct a denial of service. In contrast, an “exposure” is regarded as a problem which: Allows an attacker to conduct information gathering activities; or Allows an attacker to hide activities; or Includes a capability that behaves as expected, but can be easily compromised; or Is a primary point of entry that an attacker may attempt to use to gain access to the system or data; or Is considered a problem according to some reasonable security policy.

The following is background information on various existing vulnerability lists, databases, descriptions and interchange mechanisms currently in use. It is not intended to represent a comprehensive report regarding every available vulnerability information distribution mechanism, and for clarity, a number of methodologies for information collection and dissemination have been omitted, including; web blogs, most industry mailing lists, vendor distributions, news sites and RSS feeds.

CVE

CVE, which stands for Common Vulnerability and Exposure, is probably the most well known publicly available list of security vulnerability definitions. The MITRE Corporation maintains CVE and moderates Editorial Board discussions. CVE aspires to describe and name all publicly known facts about computer systems that could allow somebody to violate a reasonable security policy for that system. Often, these things are referred to as vulnerabilities. However, CVE Editorial Board have revealed that there are at least two common uses of the term “vulnerability.” The broad use of “vulnerability” refers to any fact about a computer system that is a legitimate security concern, but only within some contexts. For example, since the finger service reveals user information, there are reasonable security policies that disallow the finger service from being run on some systems. Thus the finger service may be regarded as a “vulnerability” according to this usage of the word. A narrower view holds that some security-related facts fall short of being “true” vulnerabilities. With respect to the presence of the finger service, it may be argued that since the finger service behaves as it was designed to behave, it should not be considered to be a vulnerability in this narrower view. CVE maintains a web site that, in addition to the vulnerability dictionary list and recent news, includes a list of CVE-compatible products and services. The dictionary is available in HTML, text or CSV formats.

The goal of CVE is to make it easier to share data across separate vulnerability databases and security tools. While CVE may make it easier to search for information in other databases, CVE cannot be considered as a vulnerability database on its own merit. The content of CVE is a result of a collaborative effort of the CVE Editorial Board that includes representatives from numerous security related organizations, such as security tool vendors, academic institutions, and government as well as other prominent security experts.

A number of organizations in the information security community provide CVE with vulnerability information that helps MITRE create new CVE candidates. This information is provided to MITRE in the form of “submissions,” which are derived from the submitting data source's vulnerability databases, probe lists from assessment tools, periodic vulnerability summaries, etc. With multiple submissions from different organizations, MITRE has a richer set of information to use when creating candidates. This improves the quality of those candidates, which in turn makes CVE more useful to all parties. For example, the resulting candidates may provide additional references for people to include in their own databases. Also, since CVE does not rely on any one source, it has a better chance of identifying all publicly known security problems, which then provides a more comprehensive set of vulnerabilities and exposures for everyone. Note that all data sources make decisions about which vulnerabilities or exposures they will include in their own database. They may exclude a security problem from their own database because it is not sufficiently proven to exist, there is incomplete information, the problem is not important to the data source's customers, etc.

A CVE data source receives a “backmap,” which links its own database items to the resulting candidate names. This helps reduce the amount of labor that the data source has to perform when mapping their database to CVE names.

The following organizations publish regular summaries of new vulnerabilities and exposures, on a weekly to monthly basis, and MITRE has been given permission to use their summaries to help keep CVE current and comprehensive with respect to the newest security problems: Security Focus—SecurityFocus.com which provides weekly newsletters (http://www.securftyfocus.com/vdb); Network Computing and the SANS Institute which provides a weekly Security Alert Consensus; ISS which provides a monthly Security Alert Summary (http:www.iss.net/alerts/summaries.php); NIPC CyberNotes which provides biweekly issues (http://www.nipc.gov/cybernotes.htm)

ICAT

ICAT, which is a proper name and not an acronym, is positioned as a CVE Vulnerability Search Engine. It is a “metabase” that represents a searchable index of information on computer vulnerabilities. It provides a granular search capability and links users to vulnerability and patch information. The ICAT Metabase is a product of the Computer Security Division at the National Institute of Standards and Technology.

ICAT and CVE have been combined and renamed as the National Vulnerability Database (NVD). NVD is a comprehensive cyber security vulnerability database that integrates all publicly available U.S. Government vulnerability resources and provides references to industry resources. It is based on, and synchronized with, the previously described vulnerability naming standard.

NVD is a product of the NIST Computer Security Division and is sponsored by the Dept. of Homeland Security-National Cyber Security Division. The NVD contains the CVE database information and is searchable using the ICAT mechanisms. The NVD provides the ability to search using a variety of criteria for vulnerabilities and incidents reported over the last three years. It provides the ability to report a vulnerability or incident and it includes US-CERT Technical Alerts, US-CERT Vulnerability Notes, US-CERT Technical Alerts or Vulnerability Notes, and OVAL Queries. The NVD provides a Workload Index that calculates the number of important vulnerabilities that information technology security operations staff are required to address each day. The higher the number, the greater the workload and the greater the general risk represented by the vulnerabilities.

The NVD workload index is calculated using the following equation: ((number of high severity vulnerabilities published within the last 30 days)+(number of medium severity vulnerabilities published within the last 30 days/5)+(number of low severity vulnerabilities published within the last 30 days/20))/30. The index equation counts five medium severity vulnerabilities as being equal in weight with 1 high severity vulnerability. It also counts 20 low severity vulnerabilities as being equal in weight with 1 high severity vulnerability. NVD provides an email alert mechanism to enable remote users to obtain timely update information.

OVAL

OVAL, which stands for Open Vulnerability Assessment Language, is a common language for security experts to discuss the technical details of how to identify the presence of vulnerabilities on computer systems using Community Forum and developed XML definitions, each of which are based on a CVE name.

CVE and MITRE's Open Vulnerability Assessment Language (OVAL) project were included as requirements in a recent U.S. Defense Information Systems Agency (DISA) task order to DigitalNet, Inc. for information assurance applications. There are XML descriptions (schema) for the OVAL language itself and three platforms are currently supported: Microsoft Windows, Solaris, and Red Hat Linux. These descriptions comprise the OVAL interface. In addition, there are over 500 OVAL definitions for testing vulnerabilities, and a handful of definitions for testing configuration items.

OSVDB

OSVDB, which stands for Open Source Vulnerability Data Base, is a project that aims to provide comprehensive, free and unbiased (no vendor spin) vulnerability information. The database is being incorporated into open source utilities such as SNORT and NESSUS. Targeting a perceived gap in the information security market where there are several vulnerability databases, some run by private companies, some having a limited subset, some with content restrictions. The database opened to public in April 2004 after two years of organizing and validating vulnerability data and creating the open-source vulnerability records. This work was done with volunteers. OSVDB has made a number of public statements regarding future direction including that (1) the project intends to publish its guidelines on “ethical vulnerability disclosure” and these will include clear guidelines on the timing of notification to the product developer, and of notification to the open security community, but how long vendors will have to come up with fixes to problems has yet to be decided; (2) the OSVDB team wants to incorporate the organization under US law, wherein the organization, tentatively named the Open Security Foundation, will be a private not-for-profit foundation and is looking to recruit volunteer participants; (3) an XML-formatted version of the database, facilitating automated querying processes, is in development; (4) the OSVDB system will also prototype automated posting of vulnerabilities through an RSS-like push mechanism, wherein subscribers will receive a new vulnerability record at the moment it is cleared into the database, and can establish customized filters to receive a subset of those records as needed; (5) the OSVDB will also help vulnerability-tool developers identify vulnerabilities that are not already recognized by their products.

In theory the OSVDB will have freedom from vendor spin and strong future potential (XML format database with query tool and automatic push distribution for new vulnerabilities). However the OSVDB suffers from unknown economic and technical viability as classification effort is done by volunteers. The quality, reliability, operational momentum is also suspect. Further the technical or economic advantages over “public” dictionary and database like CVE and ICAT isn't clear. There is no automated vulnerability test to validate whether vulnerability exists as in OVAL or automated remediation function such as in AVDL.

Secunia Security Advisories

Secunia is a Danish security service organization that has launched an independent mailing list for security vulnerabilities. The Secunia Security Advisories list is based on more than 200 different sources of security information, including VulnWatch and Full-Disclosure. All the advisories on the Secunia Security Advisories list are written, verified and qualified by Secunia staff based on security research made by the security community and Secunia's own security staff. The Security Advisories mailing list initiative is a direct competitor against Security Focus. Secunia is highly critical in published comments of Security Focus and security clearing house CERT. They have expressed the desire that the Secunia mailing list will replace Security Focus as the “source of information regarding the latest vulnerabilities and the security patches released by vendors”. Thomas Kristensen, CTO of Secunia, says: “At Seçunia, we feel that Security Focus has betrayed the community it used to serve so loyally, that's why we started Secunia”. It has been alleged by Secunia that Security Focus and CERT deliberately “delays and censors the information disclosed on BugTraq and in their vulnerability database.” The reason for any delay is attributed solely to the time needed by the list's moderators to review information, Symantec says. In the case of CERT, the more valid criticism appears to be that the organization is not doing enough to keep sensitive information confidential in light of the leak of three or four unpublished security advisories. The leaked information, taken from advance copies of advisories on cryptographic weakness in the popular Kerberos protocol, Open SSL vulnerabilities and a flaw in a Sun library, made its way onto full disclosure mailing lists ahead of patch availability. Secunia's criticism is premised on the idea that there needs to be a single source for security information in order for security to improve. This ignores the point that people in the community get their information from numerous sources, such as BugTraq, CERT, Secunia, security blogs, news sites, vendor sites etc.

Security Focus

As suggested above, Security Focus is a Vulnerability Database and was purchased by Symantec 2004, although it operates as a separate organization. Security Focus offers a wide variety of security-related information and services at no cost to visitors. Commercial information and fee paid subscriber services subsidizes the no-cost information provided. One criticism leveled at Security Focus is the delay (up to 72 hours) between the vulnerability reported through their for-pay service and public release of the information to provide a competitive edge to their commercial services. This delay applies only to information that is developed by the staff at Security Focus specifically for inclusion in the commercial services—it is not supposed to affect any information that is developed for or disclosed in other Security Focus forums, such as Bugtraq or any of the mailing lists. Security Focus claims to remain strongly committed to the full disclosure.

BugTraq

This is the Symantec solution set that also includes open mailing list forum (archived as well) hosted by Security Focus. This provides a venue for interested parties to publicly identify vulnerabilities that may not be already identified elsewhere. Obviously, it can, and has been, used to identify specific vulnerabilities for which there is no known workaround.

CERIAS

CERIAS is a Co-operative Vulnerability Database that has been sponsored by Purdue University.

CERT

Cert was established in 1988, the CERT® Coordination Center (CERT/CC) is a center of Internet security expertise, located at the Software Engineering Institute in Pittsburgh, which is a federally funded research and development center operated by Carnegie Mellon University. CERT's work involves “handling computer security incidents and vulnerabilities, publishing security alerts, researching long-term changes in networked systems, and developing information and training to help improve security.”

AVDL

AVDL, or Application Vulnerability Description Language, is an OASIS standard generated/sponsored by five vendors; SPIDynamics, Citadel, NetContinuum, GuardedNet, and Teros. The first three claimed to have already implemented AVDL 1.0 in their product line. AVDL doesn't appear to have a large following as of yet which may be due to the fact that only a small number of vendors actively support it. WAS, or Web Application, is an alternate description mechanism that involves players that didn't, or wouldn't, participate in developing AVDL. Major players that didn't participate in AVDL but are part of WAS includes Checkpoint. Further, a number of the participants in AVDL are now on a technical committee developing Enterprise Vulnerability Description Language (EVDL). ADVL moves vulnerability description beyond network security implementation and expands the scope of VDL from vulnerability description to include active mitigation or assessment component (probe). However, ADVL appears vendor-centric in design and execution and R1.0 is application-only. Further, the standards by OASIS undergo less rigor in the review and ratification process than W3C, for example. ADVL still has a perimeter view of security for applications.

It is an object of the present invention to provide security solutions that verify web services during development of the web service by testing for the latest vulnerabilities based on security, policy, and best practice profiles prior to release of the web services, and to security solutions that automate the surveillance of deployed web services so that new vulnerabilities are profiled and captured for use in verifying new software releases.

### SUMMARY OF THE INVENTION

It is noted that, as used in this specification and the appended claims, the singular forms “a,” “an,” and “the” include plural referents unless expressly and unequivocally limited to one referent. The various embodiments and examples of the present invention as presented herein are understood to be illustrative of the present invention and not restrictive thereof and are non-limiting with respect to the scope of the invention.

The invention provides a web service vulnerability metadata exchange system that provides for verification of web services during development by testing for the latest vulnerabilities based on security, policy, and best practice profiles prior to release of the web services, and wherein the web service vulnerability metadata exchange system will automate the surveillance of deployed web services so that new vulnerabilities are profiled and captured for use in verifying new software releases, wherein the system includes a metadata registry coupled to a database including vulnerability metadata, an update manager for updating the database records, and an access manager for authenticating and/or authorizing access to the database records.

Part of the unique differentiation of the present invention from prior art systems is the self-correcting, feedback loop created by integrating contemporary learning from the operational security environment into the development phase of web service creation in a more robust and automated way. A key component in this Continuous Vulnerability Assessment and Prevention solution framework is “Vulnerability Dictionary” or listing. In general, the present system uses metadata to describe and control what other systems including, test tools like the eXamine™ product (formerly from Kenai and now from Forum Systems), need to know to interact with each other, generate tests, verify and validate policies in development and production. As an example, WS-Policy describes the capabilities, requirements, and general characteristics of web services; WSDL describes abstract message operations, network protocols, and endpoint addresses used by web services; XML Schema describes the structure and contents of XML-based messages received and sent by web services. The present invention uses that metadata along with metadata derived from self-developed and public vulnerability descriptions and best practice profiles to generate multiple tests, with minimal operator intervention, for use in development, QA and production environments.

The web service vulnerability metadata exchange system of the present invention will retrieve and store the multiple types of web services metadata for use in distributed systems to facilitate a complete lifecycle approach to vulnerability management of web services. The web service vulnerability metadata exchange system of the present invention is designed as a distributed metadata information system that enables separation or co-location of components. Communication between the components are secured using mechanisms such as described in WS Security. In order to properly secure messages, the body and all relevant headers need to be included in the signature. Additionally, any standard messaging headers need to be signed with the body in order to “bind” the two together. Different security mechanisms may be desired depending on the frequency of messages. For example, for infrequent messages, public key technologies may be adequate for integrity and confidentiality. However, for high-frequency events, better performance may be obtained by establishing a security context for the events using the mechanisms described in WS-Trust and WS-Reliable Messaging. It should be noted that if a shared secret is used it is recommended that derived keys be used to strengthen the secret. Requests for metadata that are not available to anonymous parties are required to use WS-Security so that the requestor can be authenticated and authorized to access the indicated metadata. Similarly, integrity and confidentiality should be used whenever metadata has restricted access. Recipients of metadata are required to validate the signature to authenticate and verify the integrity of the data. Specifically, recipients should verify that the sender has the right to “speak” for the metadata. This is important because some metadata, such as schemas, have embedded target URIs that might be outside the scope of the sender. Additionally, metadata formats with embedded security semantics (like WS Policy) should be verified using the same considerations outlined in this section.

The following list summarizes common classes of attacks that apply to this protocol and identifies the mechanism to prevent/mitigate the attacks:
Message alteration—Alteration is prevented by including signatures of the message information using WS-Security.
Message disclosure—Confidentiality is preserved by encrypting sensitive data using WS-Security.
Key integrity—Key integrity is maintained by using the strongest algorithms possible (by comparing secured policies—see WS-Policy and WS SecurityPolicy).
Authentication—Authentication is established using the mechanisms described in WS-Security and WS-Trust. Each message is authenticated using the mechanisms described in WS-Security.
Accountability—Accountability is a function of the type of and strength of the key and algorithms being used. In many cases, a strong symmetric key provides sufficient accountability. However, in some environments, strong PKI signatures are required.
Availability—Metadata services are subject to a variety of availability attacks such as application-level denial of service. it is recommended that the mechanisms described in WS-Security be considered as mitigations for some forms of attacks. Other attacks, such as network-level denial of service are harder to avoid. NDoS protection to ensure performance
Replay—Messages may be replayed for a variety of reasons. To detect and eliminate this attack, mechanisms should be used to identify replayed messages such as the timestamp/nonce outlined in WS-Security. Alternatively, and optionally, other technologies, such as sequencing, can also be used to prevent replay of application messages.

The web service vulnerability metadata exchange system (VMX) of the present invention has the following major functional components: an Access manager that provides the authentication, authorization, and Accounting (AAA) functions for requesters of metadata; a Query Manager that processes and manages information requests for searching and sorting the metadata database; an Update Manager that processes and manages updates for other interconnected VMX systems for policy, test and vulnerability descriptions and also manages software updates; a Lifecycle Manager that provides lifecycle management of metadata contained in the metadata database; a Metadata Registry which is a UUDI/XML based registry service; an XML database that is a platform independent database capable of storing, accessing, and managing XML-based documents (Berkeley SleepyCat and Apache products are examples of Native XML databases); at least one Metadata Record which is a document of associated metadata to facilitate interchange of metadata between VMX systems; a Rich-client Browser that provides a platform independent browser capable of executing JavaScript/AJAX to perform the graphical user interface through secure distributed connection via http/https.

These and other advantages of the present invention will be clarified in the brief description of the preferred embodiment taken together with the drawings in which like reference numerals represent like elements throughout.

### BRIEF DESCRIPTION OF THE DRAWINGS

FIG. 1 is block diagram of the web service vulnerability metadata exchange system according to one aspect of the present invention;

FIG. 2 is block diagram of a distributed network of the web service vulnerability metadata exchange systems of the present invention;

FIG. 3 is block diagram of the vulnerability description exchange framework for the web service vulnerability metadata exchange system of the present invention.

### DESCRIPTION OF THE PREFERRED EMBODIMENTS

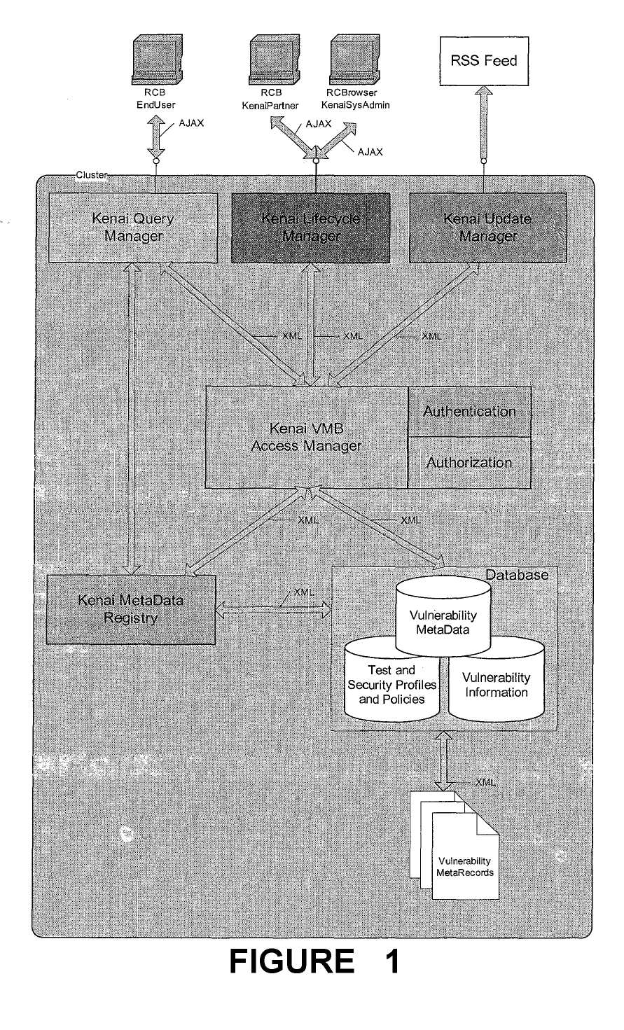

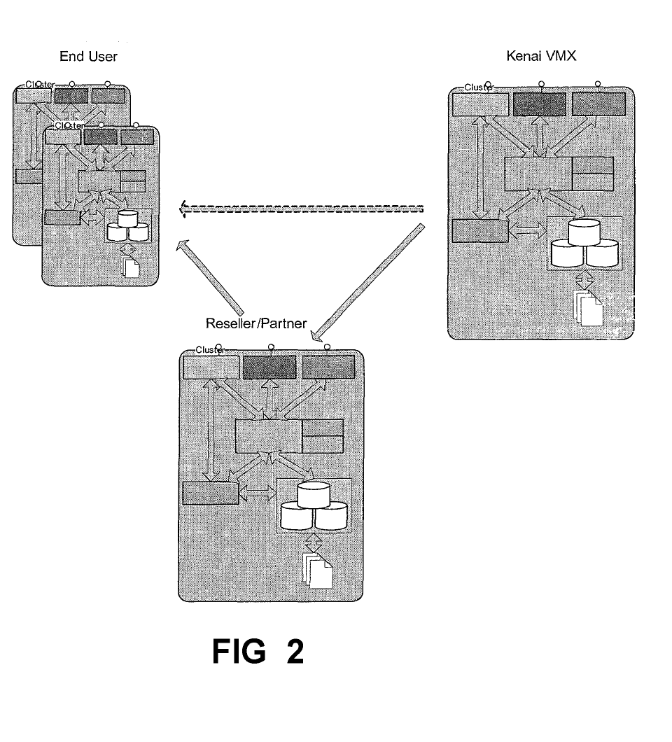

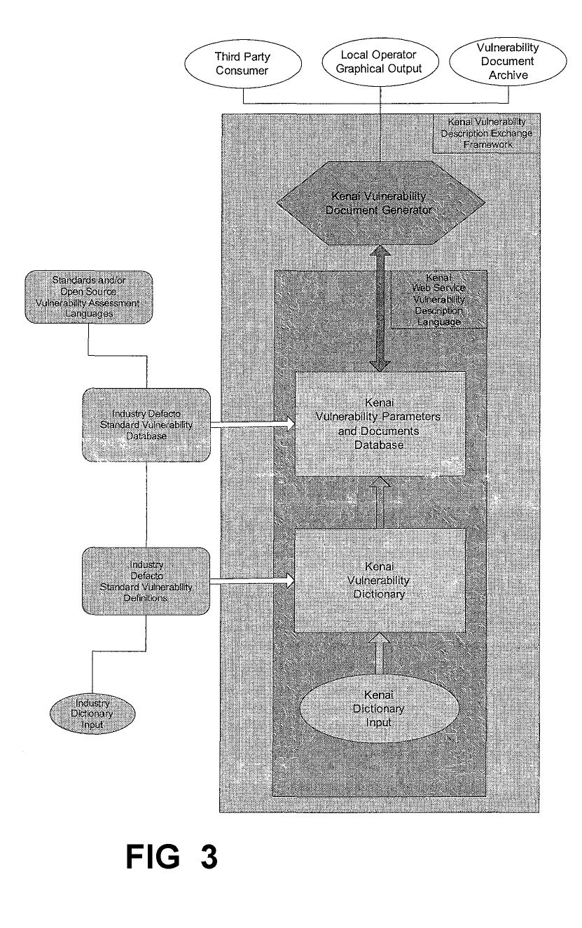

FIGS. 1-3 illustrate the web service vulnerability metadata exchange system according to the present invention. A web service vulnerability metadata exchange system that provides for verification of web services during development by testing for the latest vulnerabilities based on security, policy, and best practice profiles prior to release of the web services, and wherein the web service vulnerability metadata exchange system will automate the surveillance of deployed web services so that new vulnerabilities are profiled and captured for use in verifying new software releases, wherein the system includes a metadata registry coupled to a database including vulnerability metadata, an update manager for updating the database records, and an access manager for authenticating and/or authorizing access to the database records.

A goal of the records of the database of the web service vulnerability metadata exchange system is to specify a uniform format for describing web service vulnerabilities using an XML definition for exchanging information about the defined security and performance vulnerabilities. The web service vulnerability metadata exchange system may enable assessment tools to verify and catalog vulnerabilities, XML security gateways to optimize attack prevention, and may include a reporting tool to correlate event logs with known vulnerabilities.

The web service vulnerability metadata exchange system enables straightforward communication concerning vulnerabilities between web service entities. A descriptive specification in the records promotes and expands the transfer of vulnerability metadata. The web service vulnerability metadata exchange system of the invention will specify standards-based exchange of Vulnerability data and metadata such as utilizing XML, SOAP, WSDL, UDDI as appropriate.

The web service vulnerability metadata exchange system of the present invention enables web service security enforcement and assessment devices and systems to exchange secure, reliable, vulnerability descriptions and promote interoperability. The web service vulnerability metadata exchange system incorporates information from a selected set of third party information sources, such as, and expressly including, the databases listed previously in the background section, as well as scanners such as Nessus and Nmap.

The web service vulnerability metadata exchange system is able to map from and to CVE, OVAL, BugTraq, ICAT Metabase (NIST), and AVDL-based vulnerability definitions and databases. The web service vulnerability metadata exchange system may be considered as compatible with, if not necessarily in full compliance with, said databases.

In the web service vulnerability metadata exchange system of the invention the “Vulnerability Descriptions” are abstractions that are a source-independent schema. The web service vulnerability metadata exchange system, like the CVE database, has the requirement to use standardized names of vulnerabilities and security exposures and aims to standardize the names of all publicly known vulnerabilities and exposures.

Vulnerability descriptions and classifications should include Attack patterns (Bugs, Flaws vulnerabilities, Design Vulnerabilities) and Template descriptions (Exploit description, Attack pattern, Injection vector, Activation Zone, Output Event, Feedback Event).

Metadata, in the web service vulnerability metadata exchange system, maps into directory or registry to enable other services to consume them without knowing anything about them, i.e., find-bind-invoke methodology, Support self-discoverable service.

The web service vulnerability metadata exchange system provides for message transmission capable of transport-neutral manner, and has sufficient description to allow partners to implement part or all of the specification. The web service vulnerability metadata exchange system provides an Open source native XML database that is highly desirable to eliminate extra message transformations and optimize the small document sorting process because XML transformations of structured data in traditional relational databases is inefficient and tree traversal is memory intensive. The web service vulnerability metadata exchange system provides a standards-based open interface query toolset (e.g., XQuery). The web service vulnerability metadata exchange system provides a graphical display for human-readable output based on query.

The web service vulnerability metadata exchange system provides for generation of unique vulnerability metadata dataset as required in near real time for output to external consumers such as web service or network enforcement tools. The web service vulnerability metadata exchange system may use XML for persistence of application and object states, data-stream formatting, document representation, and a GUI structure for future proofing against changes in platform, hardware or a particular way of structuring and presenting GUIs and data (i.e. Microsoft Longhorn) since XML as a foundation means usually being able to get “there from here”.

The web service vulnerability metadata exchange system uses stochastic optimization to automate the policy generation phase of the vulnerability metadata. The web service vulnerability metadata exchange system will support business activity monitoring for event management, rules, workflow for relevance and actionability. Data may be drawn from message structure and relationships to facilitate an operational, as well as analytical, view. The web service vulnerability metadata exchange system may provide visibility into real-time operations of business processes, as well as a continuous comparison to a baseline of performance metrics to determine how well users are meeting business commitments.

The web service vulnerability metadata exchange system may use RSS for information and alert distribution and may be usable for master remediation plans.

The web service vulnerability metadata exchange system provides for default Logging requirements for XML message patterns of service applications to enable higher level analysis, and log volume threshold as one anomaly indicator to trigger on, intelligent namespace design with categories, dates, other selectors in URL/URI to enable viewing in straightforward way. The web service vulnerability metadata exchange system provides an ability to map data regarding business usage of Web services. This could include performance data such as functionality and end-to-end response as well as number times service is used. To this end a XML map of the applications to platforms and subsystems may be used.

The web service vulnerability metadata exchange system may further include a service class threshold (e.g., what's the biggest, and could also have a relationship to time-of-day or CPU usage; or is there and address range understanding (valid, not valid)). A connection, or importance, to Web services is helpful to “associate” multiple steps to derive a top level performance indicator and relate it to the vulnerability database.

The web service vulnerability metadata exchange system also includes a lexicon for defining vulnerabilities, attacks, exploits, and countermeasures specific to web services. It includes information detailing characteristics of the context of the vulnerability including information from requests and responses to web services. It also includes information on how it's found including a conformation test and the countermeasure to remediate the vulnerability. This could include an interaction with a specific application or platform. Also included is version, copyright, date and additional test and test result information (confirm vulnerability and successful remediation) along with policy association data. This lexicon may have the ability to associate with rules for enforcement devices. This could be extended from announcement of vulnerability and associated test through to rule deployment.

The web service vulnerability metadata exchange system vulnerability lexicon would be used by product developers (including the owners formerly, Kenai now Forum Systems), QA, and production test tools. For example, a penetration tool could accept this lexicon as input and generate tests to validate security profile of web services in production environment. Parameters might include: Vulnerability name, reference, Published, Summary description, Severity, Risk, Vulnerability type, Exploitable range, Loss type, References, or Vulnerable software and extensions.

Vulnerability Description Synopsis may include some or all of the following information: Vulnerable service or software exists (operating system version, name of the software or web service description file with the vulnerability in it, application version, patch status); Vulnerable configuration (indication if the service is running or not, specific configuration settings, other workarounds).

Vulnerability Definitions provide a brief overview that describes the issue to begin the detailed section of the vulnerability definition. The web service vulnerability metadata exchange system may separate detailed vulnerability definition into two sections, “Vulnerable software exists” and “Vulnerable configuration”. The web service vulnerability metadata exchange system may reuse standard sub vulnerability definitions where possible (i.e., cut and paste from existing vulnerability definitions). The web service vulnerability metadata exchange system may include comments describing what each sub-vulnerability definition is checking for. The web service vulnerability metadata exchange system may include checks for workarounds in the “Vulnerable configuration” section (i.e., turning off a service, making a program non-executable). The web service vulnerability metadata exchange system may ensure vulnerability definition accurately references the table names and columns from the official schema, and may verify that syntax is correct.

The web service vulnerability metadata exchange system is searchable and may be based on the following criteria: Vendor, Product, Version, Keyword, Severity, Filters (Common sources, Related exploit range, Vulnerability consequence, Vulnerability type, Exposed component type, Entry type, Entry date since), User Interface, Vulnerability Database (Description, Classification), Report, Delivery (WSDL SOAP RPC, HTML, RSS Feed, Email), Notification Services (WS Notification, Batch/Digest, Real time (Email, Page)), Response Options (Patch Service, Anti-Virus update, Policy update to partner technology, Registry), Information Sources (RSS Feeds, Security Focus, CVE/ICAT (NIST), OVAL, OVDSB, Secunia, BugTraq, US-CERT, ISS X-Force, LWN, CERIAS/Cassandra), Adapters/API/Device specific rules/Policy (XWall, Sentry, Systinet, Datapower, Reactivity, Network and Application firewalls, Content Router), Other system integration (Anti-Virus, Scanner, Monitors, Patch Management), Supported Use Cases (Vulnerability D&C, Alert Security Engineer, Alert Development Engineer, Send changes since last update).

The web service vulnerability metadata exchange system has some preferable Metadata database Requirements. For example, preferably the data will be stored in centralized repository, the system will support the creation of new documents, attempts to create a new document with an existing name should be prevented. Preferably, the system is not a generic document management system and will only support the following document types: Vulnerability description and classification; Test Execution results; All elements Web service package including Test Suite, Test Cases contained in a test suite, Test Operations contained under a test case, Test Templates, WS-Policy, WS Security policies, WSDLs, WS-I configuration information, and WS-I Conformance reports. The system may support the modification of existing documents without losing history, and support the deletion of documents without losing history. The system may support of the ability to request latest version of all non deleted documents in repository by type.

In one non-limiting aspect of the invention the system will support the querying of history on a given document. The system may support check-in/checkout for documents by user, wherein the only restriction on check-in is that the user who checked out the file will be the only person that can check-in. The system may support get for documents, wherein the users will be able to get not only the latest version but also gets on historical version. The system may only allow document modification for checked out files, and may support read only get of files. Only a user who has checked out the file will be able to check in file.

The web service vulnerability metadata exchange system may provide a role based security support including the following roles: a System Administrator that has full access to all aspects of system including assignment of privileges, full access to all projects and records in database; a Database Administrator that has full access to all projects in the database; a Project Owner that has full access to all projects in a given project; a Data Writer that has ability to modify data in a given project, a data Reader that has ability to view data in a given project.

The web service vulnerability metadata exchange system may allow for repository access with requiring messaging knowledge, and wherein the repository should have support for thin clients and for rich clients.

The web service vulnerability metadata exchange system may include a Repository engine of enterprise class, with Role-based access to database, Reliable messaging support, Back-up/archive capability, Transaction role forward capability, and Clean record capability.

In the web service vulnerability metadata exchange system of the invention the Repository may support queries based on document contents and Administrators may be able to remove historical items. The Repository may support the ability to label a project version and may support backing up of data and restoring from backups. The Repository may be capable of platform independence and may have Web service interface. The Repository may support CRUD operations on documents and current and historical items should support string searches.

The web service vulnerability metadata exchange system may be able to report differences between versions and may be able to report differences between execution reports.

The web service vulnerability metadata exchange system is effectively a repository of Known Vulnerability Definitions. These definitions will be associated to, and may test, generation details. The Known Vulnerability may have one to many exploits, counter measures, technical details and external references. The web service vulnerability metadata exchange system may be optimized for searching and viewing as this will be the primary use of the data. Updates, inserts and deletes will be a secondary uses of the web service vulnerability metadata exchange system. The web service vulnerability metadata exchange system may be comprised of vendor Supplied records for known vulnerabilities. The customer can customize, modify and add records to their local web service vulnerability metadata exchange system provided they have the appropriate product license.

The web service vulnerability metadata exchange system may be an integral part of a security product line such as the Forum Systems (formerly Kenai) eXamine™ product line, and explicit compatibility may be included with the system and or all versions of eXamine™ product line. The feature set for using the web service vulnerability metadata exchange system may be restricted by license for some products.

Further, the web service vulnerability metadata exchange system may be hosted by Forum Systems (formerly Kenai Systems), or by an Organization or Enterprise, or local for the installed product. The web service vulnerability metadata exchange system may be configurable, and should not be tied to the database for other eXamine objects (i.e. Policies, Test Results, WSDL, etc.). An enterprise may choose to have a single version of the web service vulnerability metadata exchange system (to reduce updating efforts), but allow each client to use an individual (local) database for test results.

Forum Systems (formerly Kenai) (or other vendor) may host a public version of the web service vulnerability metadata exchange system and restrict access by subscription levels. The hosted web service vulnerability metadata exchange system can be used by outside organizations for their Policy Driven testing; however, this will prohibit them from customizing any of the web service vulnerability metadata exchange system record details or creating User Defined VDT(s). In addition, they would effectively require a full time internet access to the web service vulnerability metadata exchange system. It may become desirable in the future for evaluators, trainees, and analysts to use the centrally hosted web service vulnerability metadata exchange system, rather than a local or distributed web service vulnerability metadata exchange system.

The web service vulnerability metadata exchange system be configurable so that a local web service vulnerability metadata exchange system can be shared by multiple users. The enterprise customer will also have the need to customize the web service vulnerability metadata exchange system for organizational best practices and policies. This functionality will be supported by configuring multiple security product clients, such as the eXamine™ product, to share a single web service vulnerability metadata exchange system. The sharing will require a dedicated full time connection to the shared resource.

The administration of web service vulnerability metadata exchange system records should be controlled by RBAC. Read, update, and delete should require authentication. A local or Enterprise web service vulnerability metadata exchange system should be capable of update from a Forum or central hosted web service vulnerability metadata exchange system.

The Vulnerabilities Explorer will be the primary user interface for locating and viewing vulnerabilities. The web service vulnerability metadata exchange system should also support an advanced search features where vulnerabilities and/or VDT(s) can be located by: VDT, Known Vulnerability, Exploit, Counter Measure, External Reference, or Technical Detail attributes.

The updating of the web service vulnerability metadata exchange system may remain a user triggered event for the upcoming release. The product should restrict the ability of updating the web service vulnerability metadata exchange system to administrators and expose the capability through RBAC.

With the web service vulnerability metadata exchange system of the invention test suite generation should be able to take advantage of the security policy to ensure that the generated test cases will include the proper security details. The security credentials will be stored with the control request and used as default credentials for all generated requests, test operations, and test cases. Each time a request is manually created, it should also inherit default security credential from the associated control request. The web service vulnerability metadata exchange system may be able to determine the compatibility between a historical test case and the current policy enabled for the service. Therefore, the web service vulnerability metadata exchange system may calculate and store the policy profile at the time of test case generation. The compatibility may be calculated and displayed when viewing test case summary views. The policy profile may also be calculated and stored for manual test case creation.

The web service vulnerability metadata exchange system may provide an ability to import new vulnerability definitions as they are released by Forum Systems, or other host vendor. The web service vulnerability metadata exchange system must allow for additions a well as updates. When a vulnerability definition is updated, all test operations, test cases, and test suites which use those vulnerabilities are suspect and the system must be able to warn the user of such concerns, or update such material. The administrator and CSO should have the ability to delete vulnerability definitions.

The web service vulnerability metadata exchange system may allow for user-defined parameter substitution vulnerabilities. The web service vulnerability metadata exchange system should present the user with a simplistic form view where they can select the element type, label, substitution option. The valid element types are initially restricted to “string”, “decimal” or “any”. The valid label values are any string value where “*” is assumed to be a wildcard unless within quotes. The valid substitution values are; “append”, “replace”, or “pre-pend”. This functionality should not be limited to a single test. The system may support multiple request tests where a list of request and expected responses can be specified. For multiple value tests, the UDV would include an URI for a data file (*,xls, *X;5) that contains a list of parameters for the request and expected response and pass/fail criteria.

Typical operating environments will use more than one method to obtain current information, sort and begin remediation efforts. There are a number of products in this space such as SkyBox to link vulnerability assessment to remediation with appropriate audit trails. A review of the aspects of the web service vulnerability metadata exchange system illustrates that the system is an improvement over even a composite of prior art systems, namely one that combines CVE for definition, ICAT for database and sort, and OVAL as the descriptive language and AVDL for application vulnerability.

The web service vulnerability metadata exchange system Metadata Registry may take advantage of existing standards including OASIS and ISO/IEC 11179. ISO 11179, Information technology Metadata Registries, is a six-part standard describing a conceptual model for collecting and organizing metadata. The semantic information contained may be collected from anywhere in an enterprises area of interest. The standard does not specify any particular implementation; the registry may be an independent product, incorporated into an existing product such as a data repository, or other system architectures as desired.

Using a metadata registry based on ISO/IEC 11179, users can store metadata about the classification; naming, identification, definition, and organization of information in order to make it understandable and shareable. Data about sources, usages, and derivation of information are made available in a readily accessible form. Also, the rules for registering and defining information units, along with other conventions, are documented. Using a conceptual metamodel allows relationships among differing representations and value sets of the same information to be mapped together in one place. This is useful for tracking the source of the XML objects generated for interchange back to the original usage, and documentation of other usages of that information within an organization.

There are some other documentation capabilities that are available in the web service vulnerability metadata exchange system Metadata Registry. For example, documentation of data structure through classification. The web service vulnerability metadata exchange system Metadata Registry provides a Classification region, in which the structure of data can be described. Namespaces are one example of a structure that can be documented in the classification region and linked to tags recorded for each entry in the Metadata Registry. Data stewardship information is also provided. The Metadata Registry has extensive provisions for documentation of the stewardship contact information for each Metadata Registry entry. Versioning capability is also possible in that every Metadata Registry entry has a built-in versioning mechanism. Visibility and Understandability is provided by linking an XML structure to an Metadata Registry based registry making additional benefits available to XML tools. Promotion of interoperability is provided in that interfaces can be documented in the Metadata Registry and made visible to users. Trustworthiness assessment can be provided in the Metadata Registry that can provide documentation for sourcing, timeliness, collection methods, and other means of confidence assurance.

One part of an Metadata Registry of particular interest to XML users is the value domain. A value domain is the set of potentially valid values for one or more Metadata Registry entries. It is used for validation of data in information systems and in data exchange. It is also an integral part of the metadata needed to describe a data element. In particular, a value domain is a guide to the content, form, and structure of the data represented by a data element. A non-enumerated value domain may be described by definition, reference, or rule. An enumerated value domain is defined by a list.

The equivalent concept to an enumerated value domain of an Metadata Registry in an XML schema is an enumerated list (properly, a restriction of a simple type to a set of ‘value’ facets), used to document the possible valid values in a domain. It is the mechanism used for listing code values. However, domains with more than just a few valid values are difficult to describe within the schema, and many code lists have hundreds of valid values. A link from an XML schema to an MDR means that the schema no longer needs to carry the code values.

The following is a non-limiting example of a vulnerabilities list associated with the web service vulnerability metadata exchange system.

### Vulnerabilities List

Trust Exploits
Direct Access to Executable files
Current working directory
Embedded scripts within scripts
Leveraged executable code in non-exec files

Server Attacks
Shell command injection
Argument injection
Command Delimiters
Multiple Parsers
Double Escapes (sim to multi-parsers)
Plumbing—ports and pipes
Permissions
File system crawl
User-supplied variable
Null terminator
Null backslash
Path traversal
Environment variables
Global variables
Session ID, Resource ID manipulation

Client Attacks
Manipulating terminal devices (reflection)

Cross Site Scripting
Script Injection
Embedded Script in non-script elements
XSS in HTTP headers
HTTP query strings
User-controlled filenames

Client Scripts
Weak local calls
Web Browsers (Active X)
Local filename subbed for URL
Email injection
Meta character in headers

Files system injection

Client buffer overflow

Buffer Overflow
Stack smashing
Injection vector

Database Overflow

Java specific (Java and C/C+)

Content-based
Overflow binary resource file
Overflow tags and variables
Overflow symbolic links
MIME conversion
HTTP cookies

Audit truncation (filter failure with overflow)

Overflow with environment variables

API call

Local command line utilities

Parameter expansion

Exception handling

Stack overflow (fixed size, auto-null terminate, exception overwrite)

Arithmetic error

Format string

Heap overflow (malloc)

Buffer overflows with C++-Vtables

Checksum/hash loading

RISC architecture-based
NUII bytes
SPARC payload constructs
SPARC register
Function call nesting
Stack walking
Stack overflow HPUX-PA
Trampolines
Canary defeat
Non-exec stack defeat

Although the present invention has been described with particularity herein, the scope of the present invention is not limited to the specific embodiment disclosed. It will be apparent to those of ordinary skill in the art that various modifications may be made to the present invention without departing from the spirit and scope thereof. The scope of the present invention is defined in the appended claims and equivalents thereto.

What is claimed is:

1. A web service vulnerability metadata exchange system that provides for verification of web services during development by testing for the latest vulnerabilities based on security, policy, and best practice profiles prior to release of the web services, and wherein the web service vulnerability metadata exchange system will automate the surveillance of deployed web services so that new vulnerabilities are profiled and captured for use in verifying new software releases, wherein the system includes a metadata registry coupled to a database including vulnerability metadata, an update manager for updating the database records, and an access manager for authenticating and/or authorizing access to the database records.
